(19) United States
(12) Patent Application Publication
(10) Pub. No.: US 2004/0070555 A1
(43) Pub. Date: Apr. 15, 2004

(54) Driving device of double-display calculating machine

(75) Inventors: Ming Wel Chuang, Taipei (TW); Ming Chih Chen, Taipei (TW)

Correspondence Address: BROWDY AND NEIMARK, P.L.L.C., 624 NINTH STREET, NW, SUITE 300, WASHINGTON, DC, 20001-5303, US

(73) Assignee: KINPO ELECTRONICS, INC., Taipei (TW)

(21) Appl. No.: 10/262,947

(22) Filed: Oct. 3, 2002

(51) Int. Cl. G09G 3/18

(52) U.S. Cl. 345/38

(57) ABSTRACT

A driving device of a double-display calculating machine includes first and second display devices and a controller that drives, at the same time, the displays of a calculation entered by an operator and being currently processed and a result thereof respectively on the first and second display devices. The first/second display device respectively includes n first/second common display inputs and m first/second segment display inputs. The controller includes a plurality of segment signal terminals and a plurality of common signal terminals. The segment signal terminals are commonly connected to the first/second segment display inputs of the first and second display devices. The common signal terminals are respectively connected to the first common display inputs of the first display device and to the second common display inputs of the second display device.

### BACKGROUND OF THE INVENTION

1. Field of the Invention

The invention relates to the driving device of a double-display calculating machine and, more particularly, to a driving device that can drive the displays of a calculation being currently performed and its corresponding result respectively on a first LCD device and a second LCD device.

2. Description of the Related Art

Currently used calculating machines generally include a single liquid crystal display (LCD) device, which is driven by a single controller integrated circuit.

A single-display calculating machine of the prior art as mentioned above may have some inconveniences. For example, if a client wishes to see the calculation being currently processed and/or its corresponding result, the cashier or vendor employee needs to adjust the calculating machine body toward the client for the keyboard and the LCD display to be clearly visible by the client. The employee then can enter the calculation before the client who thereby can control that the displayed result and the calculation entered.

A double-display calculating machine is also known in the prior art, and usually includes a protruding part that has front and rear sides formed in slightly inclined faces to respectively receive a LCD device. Each of the LCD devices is respectively connected to a single-chip processor. When the calculating machine is operated, the parameters of the calculation, under the drive of the processor, can be thereby shown at the same time on the LCD devices of the front and rear sides. The display of the display device of the rear side is further conventionally controlled via a switch.

Because the above double-display calculating machine requires two processors, each being connected to one display device, its fabricating cost is therefore not economical.

### SUMMARY OF THE INVENTION

It is therefore a principal object of the invention to provide a driving device of a calculating machine that can drive the displays of a calculation being currently performed and its corresponding result respectively on a first LCD device (oriented toward the observer) and a second LCD device (oriented toward an operator).

It is another object of the invention to provide a driving device of a calculating machine that is more economical.

To accomplish the above and other objectives, the driving device of the invention comprises a first LCD device, a second LCD device, and a controller that drives the respective displays of the first and second LCD devices. The first/second display device respectively includes a plurality of first/second common display inputs and first/second segment display inputs. The controller includes a plurality of segment signal terminals and a plurality of common signal terminals. The segment signal terminals are commonly connected to the first/second segment display inputs of the first and second display devices. The common signal terminals are respectively connected to the first common display inputs of the first display device and to the second common display inputs of the second display device. The controller thereby controls, at the same time, the displays of a calculation entered by an operator and being currently processed and its corresponding result respectively on the first and second display devices.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a block diagram of a driving device of a double-display calculating machine according to an embodiment of the invention;

FIG. 2 and FIG. 3 are circuit diagrams of a driving device of a double-display calculating machine according to an embodiment of the invention; and

FIG. 4 is a schematic view showing the implementation of the driving device in the double-display calculating machine according to an embodiment of the invention.

### DETAILED DESCRIPTION OF THE EMBODIMENTS

Wherever possible in the following description, like reference numerals will refer to like elements and parts unless otherwise illustrated.

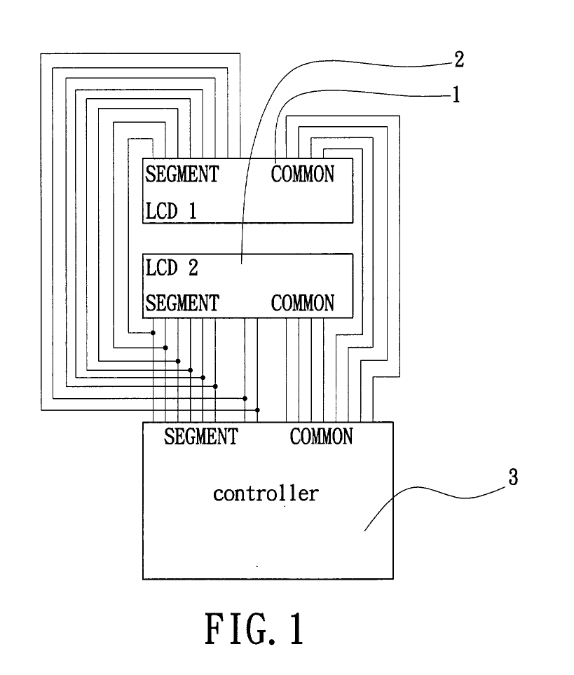

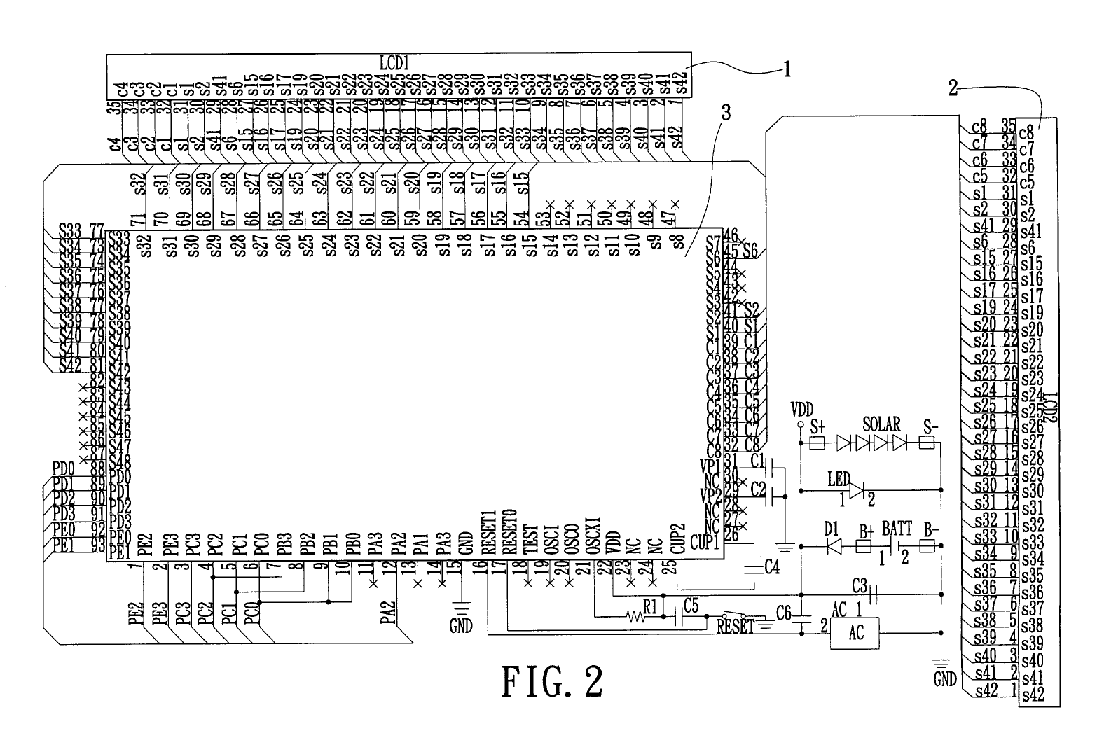

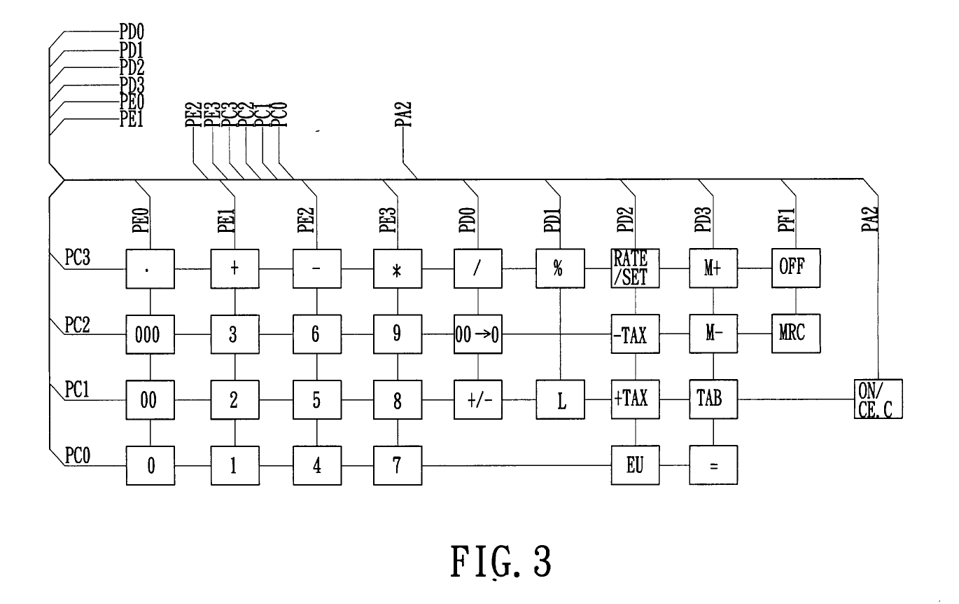

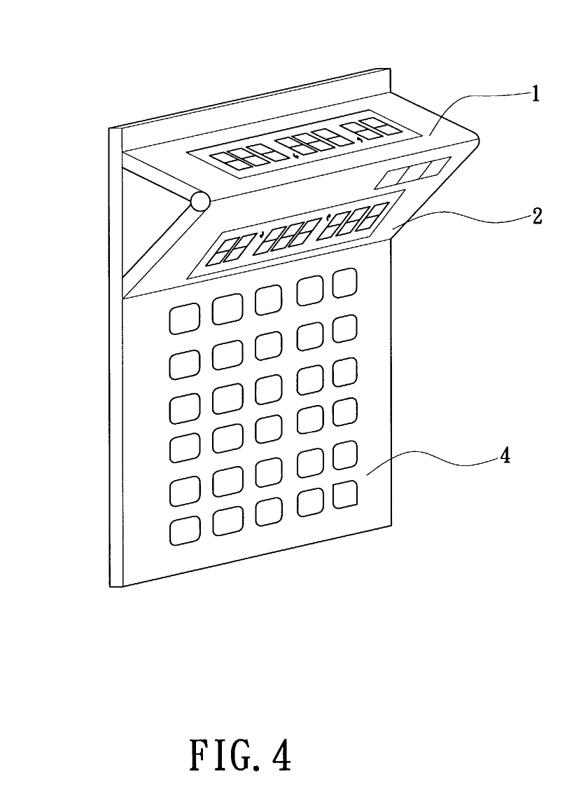

Reference now is made to FIG. 1 through FIG. 4 to describe a driving device of a double-display calculating machine according to an embodiment of the invention. According to one aspect of the embodiment, the functions of the driving device includes the control at the same time of the respective displays of two liquid crystal display (LCD) devices, including the displays of the calculation entered by the user and its result. The driving device comprises a first LCD device 1, a second LCD device 2, and a controller 3 that drives the first and second LCD devices 1, 2.

In this embodiment, the first LCD device 1 uses a ⅛-duty liquid crystal, and is designed with a ¼-duty LCD pinout including four first common display inputs C1-C4 and a plurality of first segment display inputs.

The second LCD device 2 uses a ¼-duty liquid crystal, and is designed with a ¼-duty pinout including four second common display inputs C5-C8 and a plurality of second segment display inputs.

The controller 3 is typically a controller integrated circuit (IC) with ⅛-duty and ¼-bias output signal. The controller IC includes a plurality of segment signal terminals S1, S2, S6, S15-S42 and eight common signal terminals C1-C8. The segment signal terminals S1, S2, S6, S15-S42 are commonly connected to the first and second common segment display inputs of the first and second LCD devices 1, 2, so that both LCD devices 1, 2 are enabled to commonly receive the segment signals from the controller 3. The eight common signal terminals C1-C8 of the controller 3 are respectively connected to the first common display inputs C1-C4 of the first LCD device 1 and the second common display inputs C5-C8 of the second LCD device 2. The controller 3 thereby controls the displays, at the same time, of the calculation entered by an operator and its results respectively on the first and second LCD devices 1, 2.

When the operator, by means of the calculating machine body 4, keys in the calculation to process, the controller 3 controls, at the same time, the displays of the calculation being performed and its result respectively on the first and second LCD devices 1, 2. By an adequate orientation of the LCD devices 1, 2, the operator of the calculating machine and another observer are thereby simultaneously and conveniently informed of the calculations being currently processed and the results of the corresponding calculations.

As described above, the driving device of the invention includes the following advantages.

1. At least two LCD devices are driven by a driver at the same time to display the calculation being processed and its result.

2. Since the operator and another observer are informed at the same time of the calculation being currently processed and its result, the use of the calculation machine is more user-friendly.

3. The driving device of the invention uses a single IC chip for controlling two LCD devices, which represents an economical design.

Those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A driving device of a double-display calculating machine, comprising:
a first display device, including n first common display inputs and m first segment display inputs;
a second display device, including n second common display inputs and m second segment display inputs; and
a controller, including a plurality of segment signal terminals and a plurality of common signal terminals, the segment signal terminals being commonly connected to the first and second segment display inputs of the first and second display devices, and the common signal terminals being respectively connected to the first common display inputs of the first display device and to the second common display inputs of the second display device, the controller thereby controlling, at the same time, the displays of a calculation entered by an operator and being currently processed and a result thereof respectively on the first and second display devices.

2. The driving device of claim 1, wherein the first display device includes a ⅛-duty liquid crystal.

3. The driving device of claim 1, wherein the second display device includes a ¼-duty liquid crystal.

4. The driving device of claim 1, wherein the controller uses a controller integrated circuit chip of ⅛ duty and ¼ bias.
